(19) United States
(12) Patent Application Publication
(10) Pub. No.: US 2002/0096959 A1
(43) Pub. Date: Jul. 25, 2002

(54) Transposed winding for random-wound electrical machines operating at high frequencies

(75) Inventors: Dinyu Qin, Chatsworth, CA (US); Michael Swinton, Fallbrook, CA (US); Jan Swinton, Fallbrook, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CAPSTONE TURBINE CORPORATION, Chatsworth, CA

(21) Appl. No.: 09/985,387

(22) Filed: Nov. 2, 2001

Related U.S. Application Data
(60) Provisional application No. 60/245,704, filed on Nov. 2, 2000.

(51) Int. Cl. H02K 3/04

(52) U.S. Cl. 310/208

(57) ABSTRACT

A random-wound winding for an electrical machine including interconnected wire layers, wherein the interconnected wire layers include randomly wound wires and are configured upon placement in the electrical machine to have substantially the same impedance. Accordingly, the random wound windings can include a first coil having layers of wires randomly wound on the first coil with the layers configured in a first layering order, a second coil having layers of wires randomly wound on the second coil with the layers configured in a second layering order transposed relative to the first layering order, and at least one electrical interconnection configured to serially connect the layers of the first coil to the layers of the second coil such that an average axial position of all interconnected layers is substantially the same. The random wound windings can include a coil having layers of wires randomly wound on the coil with one side of the coil having the layers configured in a first layering order and an opposing side of the coil having the layers configured in a second layering order transposed relative to the first layering order, wherein an average axial position of the layers substantially the same.

### CROSS-REFERENCE TO RELATED APPLICATIONS

This patent application claims benefit of and priority to U.S. provisional application Ser. No. 60/245,704 filed Nov. 2, 2000, and the entire contents of the provisional application are incorporated herein by reference.

### BACKGROUND OF THE INVENTION

1. Field of the Invention

This invention relates to the general field of high-frequency electrical machines, and more particularly to an improved system and method to reduce the current migration effect acting on windings in electrical machines.

2. Discussion of the Related Art

As used herein, a wire means a long strand of conductive material. An electrically insulating sheath or coating can surround the conductor surface of the strand. On wires, the skin effect constrains high frequency (HF) electric current carried by the wires to flow in an outer cross-sectional area of the conductive cross-section of each wire. Fine-gauge wires, whose thickness is generally less than two skin depths, are used to carry HF current. Wires having a cumulative cross section significantly thicker than twice a skin depth have conductive material at the center of each wire in which little if any current is carried. For a fixed wire, a specific number of wires is required to provide a specific conductance at a specified frequency.

For example, Litz wire is a wire constructed of individually film insulated conductive braided together in a uniform pattern of twists. The multi-strand configuration (i.e, the pattern of twists) is designed to minimize power losses otherwise encountered in a solid conductor due to the skin effect. Litz wire is commonly used in HF electrical machines on the stator and rotor windings.

When multiple wires are used to collectively carry a HF current, either of the mutual inductance of one wire to another or the self inductance to metal structures proximate to the current-carrying wires can produce a current migration effect in which each wire having a different relative impedance to the other wire carries for the same electromotive force a different magnitude of current. The current migration effect influences the design and operation of various electrical machines including especially, but not limited to, HF electrical motors and generators.

Referring to FIG. 22, FIG. 22 shows stator stack 2210 without windings. In stator stack 2210, windings of current-carrying wires (all wired in parallel) are inserted into slots 2212 in stator stack 2210. The above-noted current migration effect causes current migration to those current-carrying wires which are closest to slot openings 2214. As a result, the effective number of current-carrying wires available to carry current is smaller than the actual number of current-carrying wires, thus also increasing the resistance (i.e. power loss) in the motor. Since the current migration effect increases with frequency, increased power losses are amplified as the frequency of the motor increases.

Referring to FIG. 23, it shows a cross-sectional view of a 3-phase 2-pole stator with a conventional form-wound winding 2322. Form-wound winding 2322 has a very regular format for each wire strand 2324 on the form. Each wire-strand 2324 is located at a known position in stator slot 2326.

Referring to FIG. 24, it shows the magnetic flux generated by windings 2402 of a 3-phase 2-pole stator. FIG. 24 shows a cross-sectional view of stator assembly 2404 and winding 2402. In this 2-pole example, 2-pole flux lines 2406 are plotted. For this form-wound winding, four strands in both the top half and bottom half slots are connected in parallel. Due to the current migration effect, currents in the 4 parallel strands either in the top or the bottom half of a slot tend to migrate from the strands close to the slot bottom to the strands close to the slot opening.

In large current rating electrical motors or generators (normally operated at 60 Hz), the copper skin depth is close to the coil dimensions, and a winding transpose (not shown) may be used to reduce the current migration problem by interconnecting in series wire strands 2424a near opening 2428 of each stator slot 2426 with wires strands 2424b near well 2430 of each stator slot 2426. Thus, currents are forced by the winding transpose to flow uniformly among all the strands in parallel, balancing the current distribution on all wire strands 2424 of the form-wound winding.

### SUMMARY OF THE INVENTION

Besides conventional form-wound windings, electrical motors and generators are wound using random-wound windings with no form present to ensure the format and placement of the wires in the stator slots. Rather, individual insulated wires are randomly placed into the stator slots with no knowledge of where within the slots each wire will be located. As a consequence, it was not thought possible, prior to the present invention, that wiring transposed could be utilized to mitigate current migration problems, especially prevalent in HF electrical motors and generators.

In one aspect, the invention provides a novel random-wound winding for an electrical machine including interconnected wire layers, wherein the interconnected wire layers include randomly wound wires and are configured upon placement in the electrical machine to have substantially the same impedance.

In one aspect of the present invention, the high frequency electrical machine can be a turbogenerator having a compressor configured to compress a fuel oxidizer, a fuel supplier configured to supply fuel to the turbogenerator, a combustor connected to an exhaust of the compressor and configured to combust the fuel and the fuel oxidizer into a combusted gas, a turbine connected to an exhaust of the combustor and configured to convert heat from the combusted gas into rotational energy, and a motor/generator configured to convert the rotational energy in the turbine into electrical energy.

In another aspect of the present invention, the high frequency electrical machine can be utilized as an electrical motor, a electrical generator, a transformer, an antenna, an alternator, or a synthesizer in which the windings are randomly-wound and placed nearby non-current carrying metallic structures.

In another aspect of the present invention, a random wound winding of the present invention can be made by winding randomly layers of a first half and a second half of a winding on a coil form, transferring the winding from the coil form to a coil transfer tool, inverting the coil transfer tool about a midpoint, and inserting the layers of the winding on the coil transfer tool into an electrical machine.

In another aspect of the present invention, a random wound winding of the present invention can be made by winding randomly wire layers of a coil on a coil form in a sequential layering order, transposing one half of active portions of the wire layers to produce a layering order for the one half inverted with respect to the sequential layering order, and inserting the wire layers of the coil on the coil form into an electrical machine.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is perspective view, partially in section, of an integrated turbogenerator system;

FIG. 1B is a magnified perspective view, partially in section, of the motor/generator portion of the integrated turbogenerator of FIG. 1A;

FIG. 1C is an end view, from the motor/generator end, of the integrated turbogenerator of FIG. 1A;

FIG. 1D is a magnified perspective view, partially in section, of the combustor-turbine exhaust portion of the integrated turbogenerator of FIG. 1A;

FIG. 1E is a magnified perspective view, partially in section, of the compressor-turbine portion of the integrated turbogenerator of FIG. 1A;

FIG. 2 is a block diagram schematic of a turbogenerator system including a power controller having decoupled rotor speed, operating temperature, and DC bus voltage control loops;

FIG. 3 is a schematic illustration of a stator assembly;

FIG. 4 is a schematic illustration depicting a single turn on a coil having an active portion (i.e. the straight portion) to be inserted in stator slots of the stator assembly;

FIG. 5A is a schematic illustration of a coil containing multiple parallel wires in the depicted single turn;

FIG. 5B is a schematic view of the outside of a stator assembly showing the protruding end portions of the coil turns;

FIG. 6 is a schematic illustration of a coil set of a winding having an inter-coil connection;

FIG. 7 is a schematic illustration of a winding including two coil sets connected in parallel without a transpose;

FIG. 8 is a schematic illustration of an in-slot view of the winding depicted in FIG. 7;

FIG. 9 is a schematic illustration of a winding including two coil sets connected in parallel with a transpose according to the present invention;

FIG. 10 is a schematic illustration of an in-slot view of the winding depicted in FIG. 9;

FIG. 11 is a schematic illustration of a winding including 6 coils;

FIG. 12 is a three-dimensional schematic illustrating a single coil on a transfer tool;

FIG. 13 is a two-dimensional schematic illustrating a single coil on the transfer tool of FIG. 12;

FIG. 14 is a two-dimensional schematic illustrating a coil having nine layers on the transfer tool of FIG. 12;

FIG. 15 is a two-dimensional schematic illustration of a complete phase winding without a transpose;

FIG. 16 is a graph depicting the current distribution in each strand of a winding of a coil set without a transpose as a function of the strand diameter number;

FIG. 17 is a two-dimensional schematic illustration of a complete phase winding with a transpose according to the present invention;

FIG. 18 is a two-dimensional schematic illustrating a coil having nine layers after a transpose according to the present invention;

FIG. 19 is a graph depicting the current distribution in each strand of a winding of a coil set with a transpose as a function of the strand diameter number;

FIG. 20 is a two-dimensional schematic illustrating a coil having an internal transpose of coil layers;

FIG. 21A is a flowchart depicting a method of making a high frequency electrical machine of the present invention;

FIG. 21B is a flowchart depicting another method of making a high frequency electrical machine of the present invention;

FIG. 21C is a flowchart depicting a method of using a high frequency electrical machine of the present invention;

FIG. 22 is a schematic illustration of a stator stack without windings;

FIG. 23 is a schematic illustration of a cross section of a 3-phase 2-pole stator with a form winding;

FIG. 24 is a plot of magnetic flux around the 2-pole stator of FIG. 23.

### DETAILED DESCRIPTION OF THE EMBODIMENTS

Various other objects, features and attendant advantages of the present invention will be more fully appreciated as the same becomes better understood from the following detailed description when considered in connection with the accompanying drawings in which like reference characters designate like or corresponding parts throughout the several views.

Mechanical Structural Embodiment of a Turbogenerator

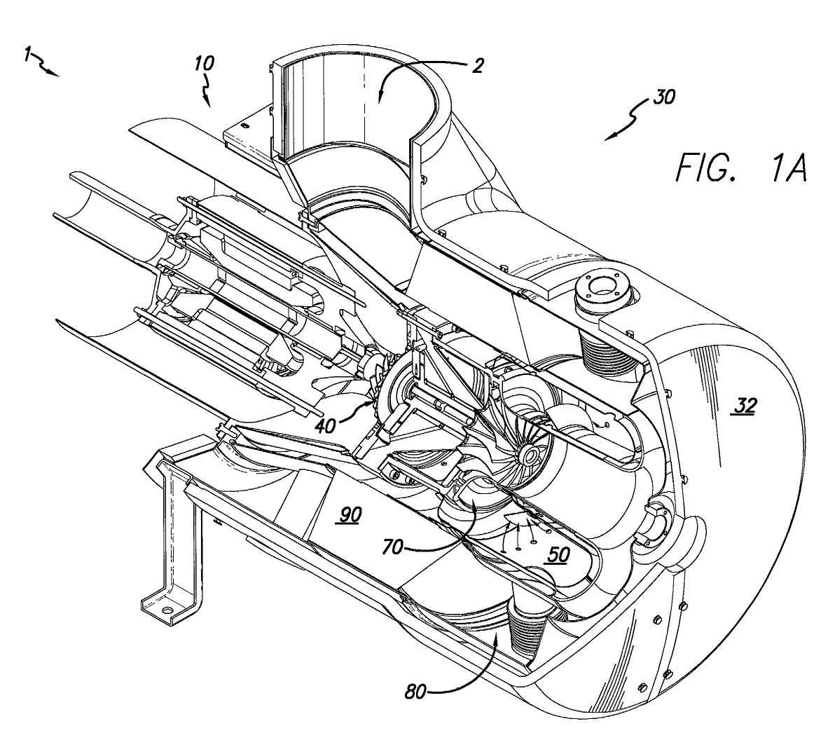

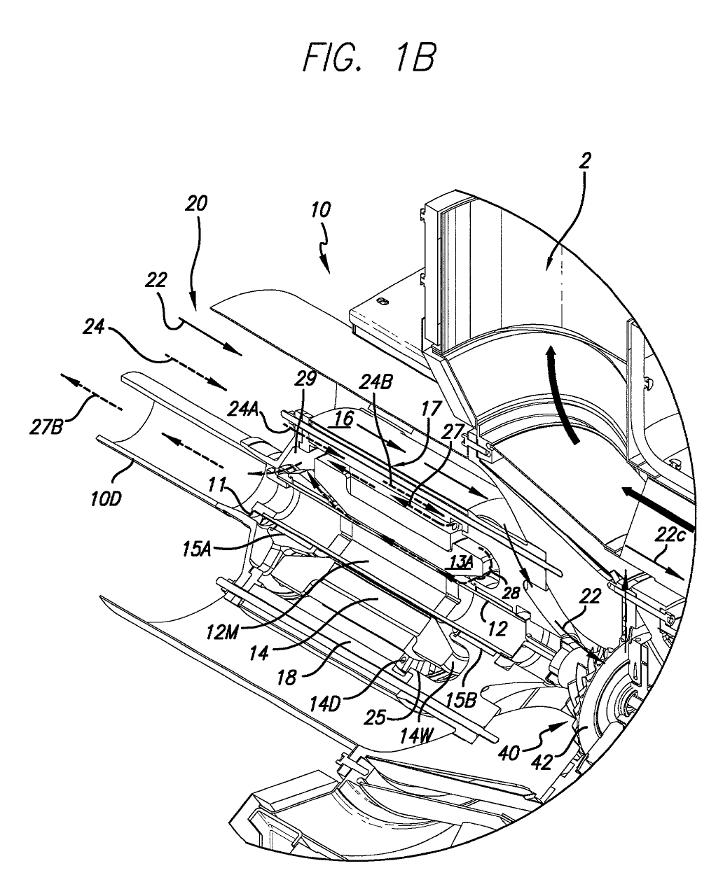

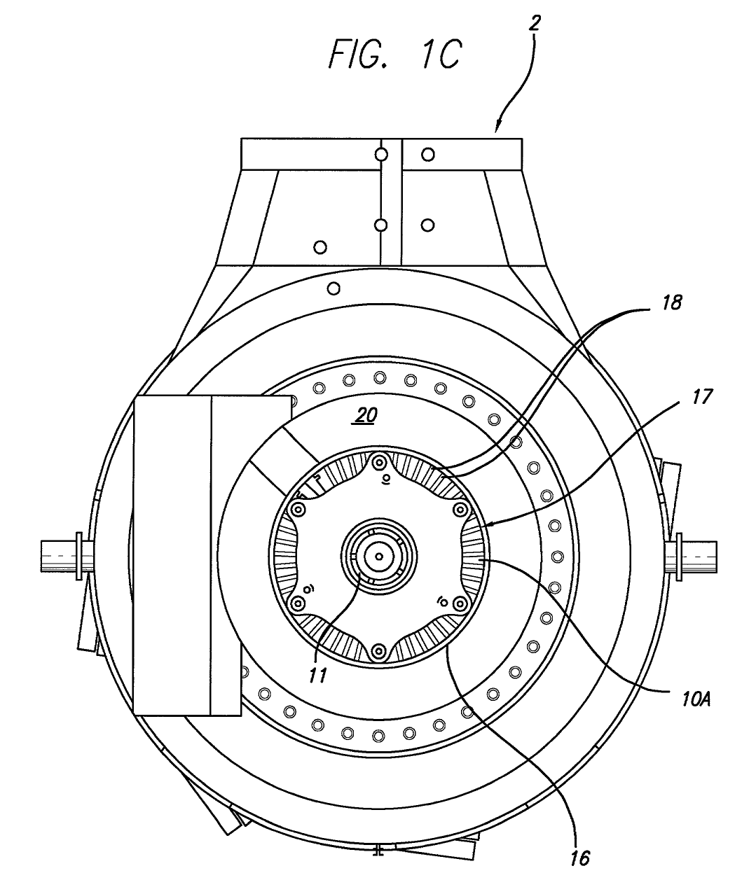

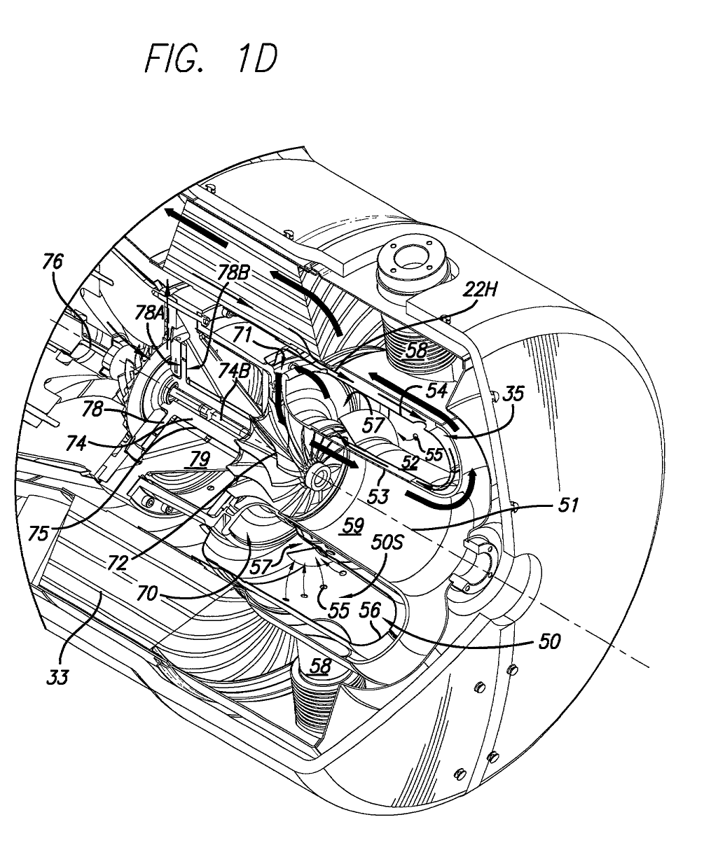

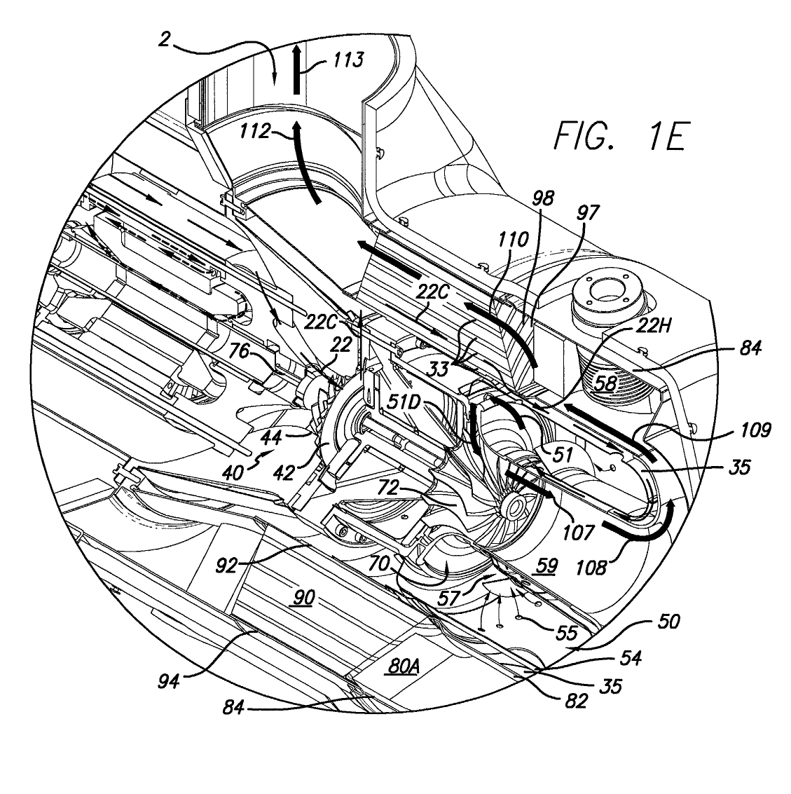

With reference to FIG. 1A, an integrated turbogenerator 1 according to the present invention generally includes motor/generator section 10 and compressor-combustor section 30. Compressor-combustor section 30 includes exterior can 32, compressor 40, combustor 50 and turbine 70. A recuperator 90 may be optionally included.

Referring now to FIG. 1B and FIG. 1C, in a currently preferred embodiment of the present invention, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

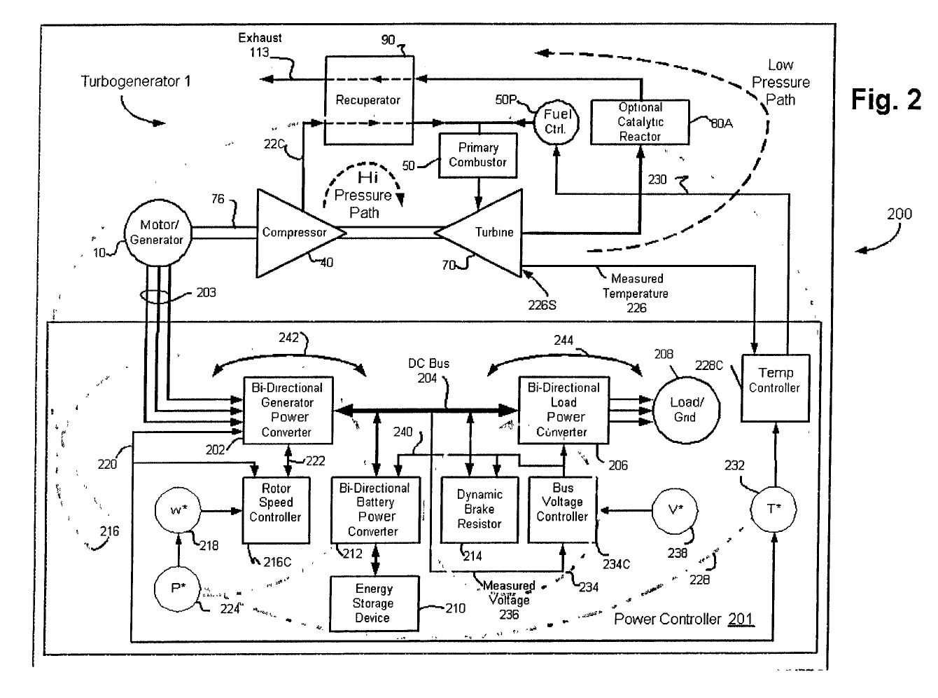

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 51. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 76 is rotatably supported preferably by a bilateral thrust bearing 78A and 78B. Journal or radial bearing 75 and thrust bearings 78A and 78B may be fluid film or foil bearings.

Turbine wheel 72, Bearing rotor 74 and Compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 98 of recuperator 90, as indicated by gas flow arrows 108 and 109 respectively.

In an alternate embodiment of the present invention, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

Alternative Use of the Invention Other than in Integrated Turbogenerators

An integrated turbogenerator is a turbogenerator in which the turbine, compressor, and generator are all constrained to rotate based upon rotation of the shaft to which the turbine is connected. The invention disclosed herein is preferably but not necessarily used in connection with a turbogenerator, and preferably but not necessarily used in connection with an integrated turbogenerator.

Turbogenerator System Including Controls

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

Windings in the motor generator discussed above preferably have at least one of the structures indicated below.

Windings of the Present Invention

The current rating of an electrical motor, electrical generator, or high frequency electrical machine depends on the current rating of electrically insulated wires wound as windings in the stators and/or rotors of for example the electrical motor or generator. The current rating of the motor, generator, or high frequency electrical machine is limited by heat dissipation from the individual current carrying wires which must in turn dissipate heat typically through a wire insulation to the environment. If the current in one wire of the winding is higher than current in other wires, it will be most likely the wire carrying the higher current which breaks down first and limits the performance of the motor, generator, or high frequency machine. A description of high speed motor drives can be found in Mekhiche et al., “High Speed Motor Drive Development for Industrial Application,” 1999 IEEE, International Electric Machines and Drive Conference, pp. 244-248. The entire contents of Mekhiche et al. are incorporated herein by reference. A description of asynchronous electric machines and rotors and stators can be found in U.S. Pat. No. 5,473,211. The entire contents of U.S. Pat. No. 5,473,211 are incorporated herein by reference.

For electrical machines operating at 60 Hz, a wiring transpose between individual wires or strands of coil sets of the windings would normally not be required as at 60 Hz the copper skin depth is large compared to the coil dimensions and the current migration problem is small. However, at higher frequencies than 60 Hz the current migration problem will be pronounced and limit the performance of the electrical machine. The coil set of the present invention addresses issues associated with balancing current distributions in random-wound windings utilized in high frequency electrical machines.

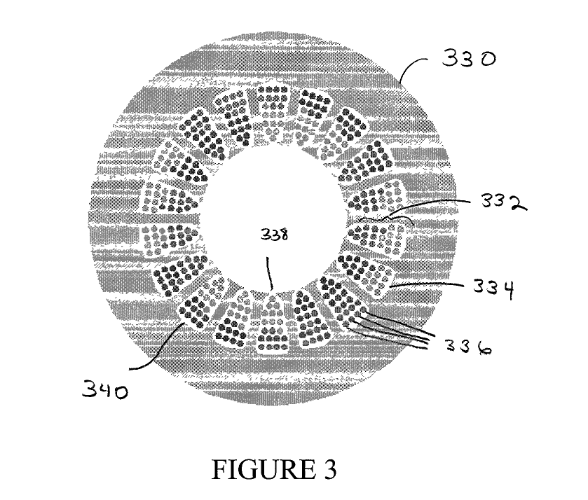

Referring to FIG. 3, it shows a cross-sectional view of 3-phase 2-pole stator 330 having random-wound windings 332, with each phase occupying half-portions of twelve stator slots 334 of stator 330. The conductors, i.e. wire strands 336, of a random-wound winding normally are made of electrically insulated magnet wires. Due to the flexibility of these wires, the position of each of wire strand 336 (defined as a single wire) can not be easily controlled in the slots, and consequently is not known after the placement of the wire strands in the stator slots.

Two factors would appear to negate one from utilizing a wiring transpose in a random-wound winding. First, in a random-wound winding, the coil sets typically include a large number of wires, as smaller more flexible current-carrying wires are used in the random-wound winding assembly than in the form wound windings discussed previously. The large number of wires imposes difficulties on connecting transposed connections from one wire strand of a coil to another. Second, the softness and flexibility of each magnet wire used in the random-wound windings make it difficult, if not impossible, to control each wire position in the stator slot. This difficulty in knowing each wire position in the stator slot is compounded by the assembly process which feeds the wires down through the restricted slot openings such as slot opening 338 shown in FIG. 3 before the wires settle into the stator slot. Thus, with no knowledge of each wire position relative to the slot opening in the random-wound winding, it seems counterproductive to wire interconnections between individual wires or strands of neighboring coils in the windings, as the interconnections would as likely interconnect wires or strands with similar relative positions relative to the slot opening as to interconnect wires or strands with different relative positions.

According in one embodiment of the present invention, multiple electrically insulated wires of a coil set (i.e. a first coil and a second coil) of the present invention are wound both in parallel and in wire layers to build a large number of parallel wires. The parallel wires are connected together at the ends of each wire to form a composite conductor, but as shown in FIG. 3 have a random placements in the stator slots. However, in the present invention, the random-wound windings maintain some degree of relative positioning within each of the stator slots.

According to the present invention, respective wire layers on a second coil are inverted or transposed relative to the first coil so that what was a top wire layer near slot opening 338 in the first coil is connected to a bottom wire layer in the second coil near slot well 340. Each progressive layer in between is likewise transposed.

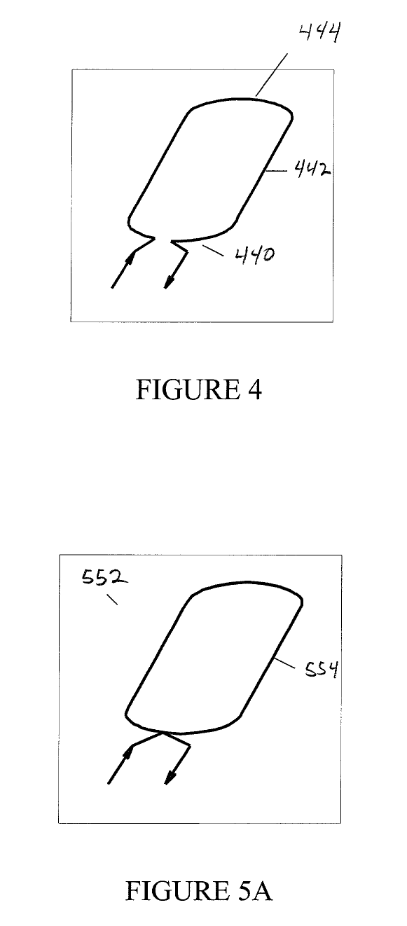

A coil is generally made with a certain number of turns having a certain number of wires in parallel. Referring to FIG. 4, FIG. 4 depicts a singular layered one-turn coil 440. In FIG. 4, the coil includes straight or active portions 442 and end portions 444. The straight portions are inserted into the stator slots such as stator slot 334 and run axially along a length of the stator before exiting the stator stack.

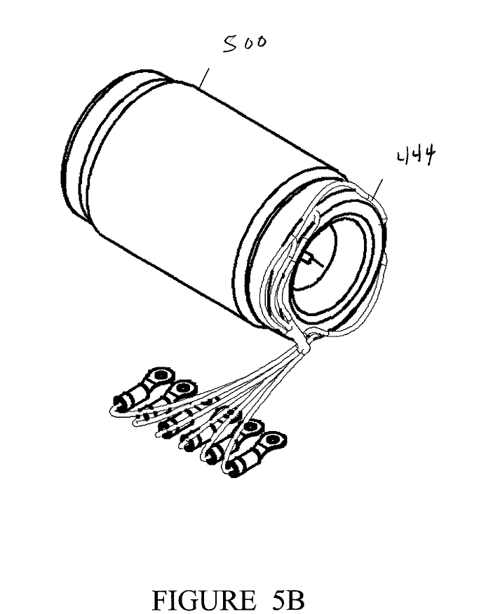

Referring to FIG. 5A, it depicts a coil set 552 having a certain number of turns (e.g. perhaps five turns) of a certain number of strands in a single wire layer 554.

Referring to FIG. 5B, it depicts stator assembly 500 where end portions 444 connect to other stator slots (not shown) in stator assembly 500.

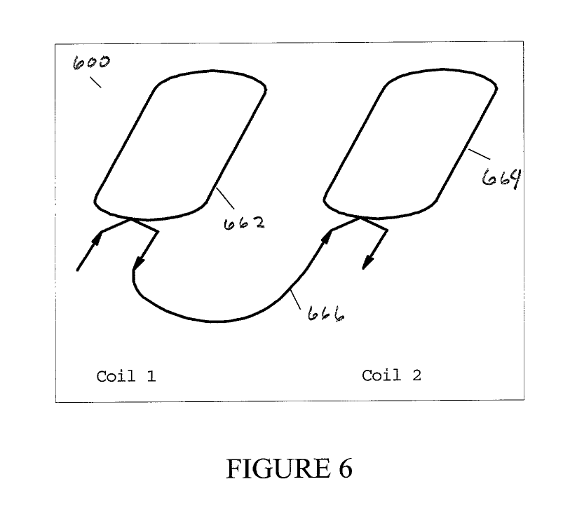

Referring to FIG. 6, it depicts a coil set 600 with two coils 662, 664 wired in parallel. Wires in the coils connect across via a coil connection 666 connects between the coils 662, 664.

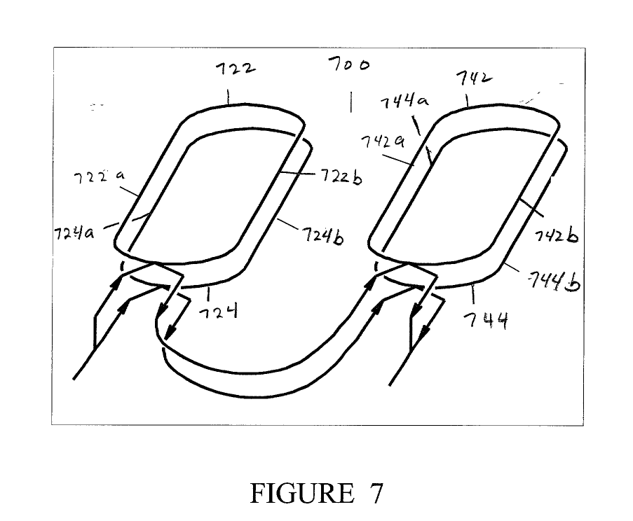

Referring to FIG. 7, it depicts winding 700 including one or more coil sets. One coil set includes two coils 722, 742, The other coil set includes two coils 724, 744. The coil sets are connected through parallel and/or series connections. Each of the coils 722, 724, 742, and 744 have active portions 722a, 722b, 724a, 724b, 742a, 742b, 744a, and 744b. In FIG. 7, the coil sets are connected in parallel and the active portions are placed in pairs in four slots of a stator (i.e 722a and 724a in one slot, 722b and 724b in another slot, etc.). If one active portion is inserted into the slots before another one, then the first inserted active portion is near a slot bottom area (e.g near slot well 888). When another active portion is inserted on top of the first inserted active portion, this active portion is located closer to a slot opening area (e.g. near slot opening 886). An active in the slot bottom area has a larger leakage inductance (i.e. an inductance associated with the strand's deeper depth in the slot) than an active portion near the slot opening area.

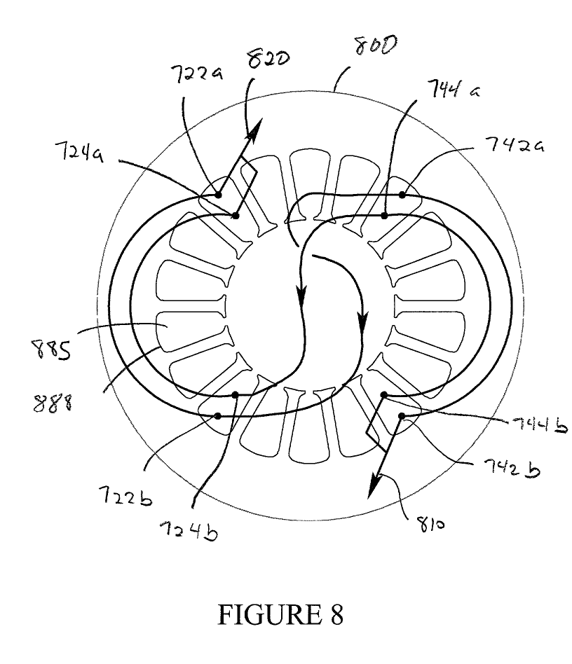

Referring to FIG. 8, it shows conventional interconnections between the two coil sets inserted into a stator assembly 800. FIG. 8 shows that active portions 722a, 722b , 742a, and 742b occupy a part of slot 885 closest to slot well 888 and active portions 724a, 724b, 744a, and 744b occupy a part of slot 885 closest to slot opening 886. Consequently, active portions 722a, 722b, 742a, and 742b have a higher inductance than a strand of coil 82. Interconnections 887 and 889 connect respectively two coil sets 740 and 720.

When two terminals 810 and 820 of the winding (or coil sets) are connected to an AC voltage, current will preferentially be conducted in the active portions closer to slot opening 886. In high frequency electrical machines, it appears as that wires of the active portions closer to the slot opening carry more current than the wires closer to the slot bottom, i.e. the current migration problem. The current migration, as previously discussed, causes power losses, can severely increase winding heating, raise the winding temperature, and shorten the winding lifetime.

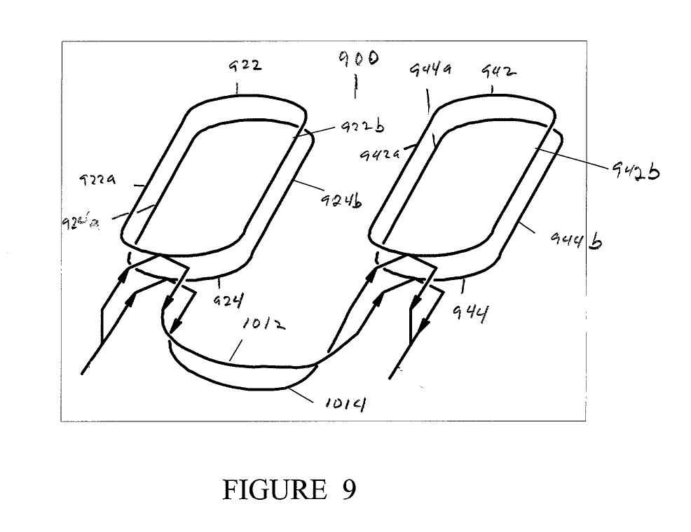

Referring to FIG. 9, it shows winding 900 including two coil sets. One coil set includes two coils 922, 942, The other coil set includes two coils 924, 944. The coil sets are connected through parallel and/or series connections. Each of the coils 922, 924, 942, 944 have active portions 922a, 922b, 924a, 924b, 942a, 942b, 944a, and 944b. In FIG. 9, coil sets 920 and 940 are connected in parallel with interconnections 996. If one active portion is inserted into the slots before another one, then the first inserted active portion is near a slot bottom area (e.g near slot well 988). When another active portion is inserted on top of the first inserted active portion, this active portion is located closer to a slot opening area (e.g. near slot opening 986). An active in the slot bottom area has a larger leakage inductance (i.e. an inductance associated with the strand's deeper depth in the slot) than an active portion near the slot opening area.

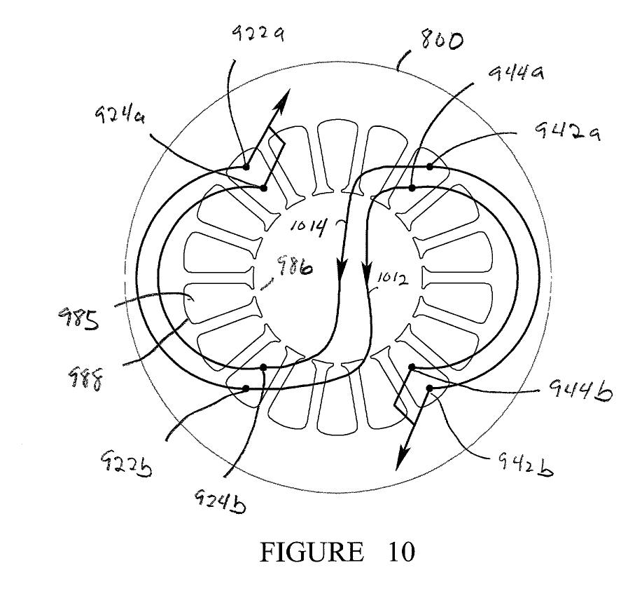

Referring to FIGS. 9 and 10, these figures show transposed interconnections 1012, 1014 of the present invention which connect between two coil sets 920 and 940. Interconnections 1012, 1014 are connected in series between coil sets 920 and 940, and cross-connect (i.e. a transpose) the connections to the active portions. Thus, the differences in inductance in the active portions of the winding will be, according to the present invention, mitigated.

Approaches similar to those shown in FIGS. 7-10 were applied to windings in a machine-wound stator, i.e. a stator being wound by automatic stator manufacturing equipment. Automatic equipment manufacturing equipment improves consistency in quality and provides better economics for higher production. Automatic stator manufacturing equipment does imposes additional restrictions on how stator windings are fabricated. For a 3-phase stator in a 30 kW product, each phase winding has six coils in series, with each coil having 4 turns of 27 strands of magnet wire connected in parallel.

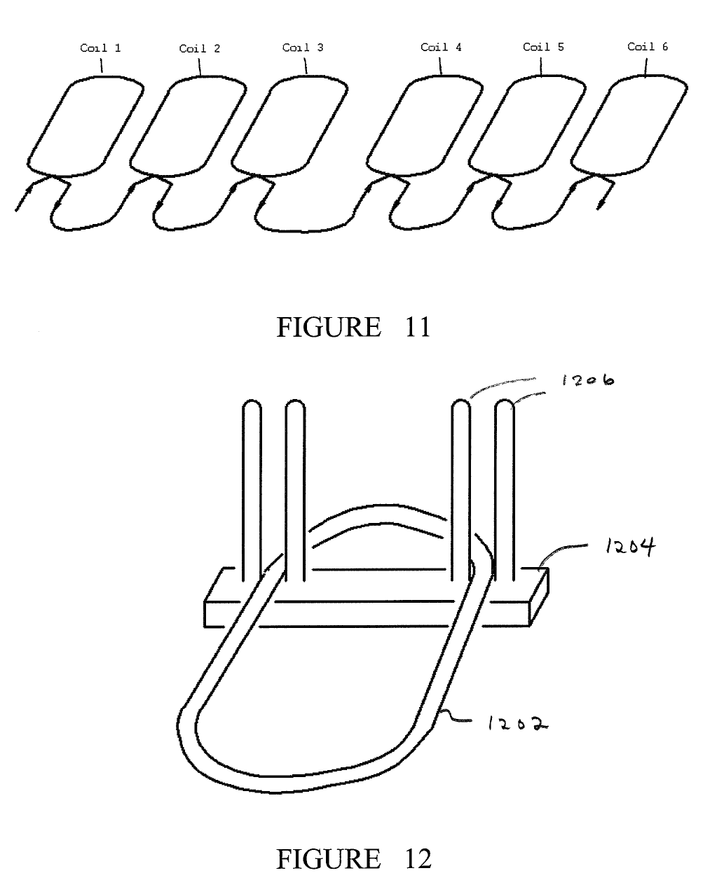

Referring to FIG. 11, it shows a phase winding layout for six coils of the above noted 30 kW electrical machine. Each coil includes 4 turns of 27 strands. In reality, it is impossible for a fully automatic winding machine to wind 27 strands simultaneously. The maximum number of strands in which an automatic winding machine (i.e. a winder) can normally handle is from 5-8 strands. Thus, the 27 strands are divided into 9 groups of 3 strands. That is a phase winding is made of 9 coil sets, with each coil set having 6 coils of 4 turns of 3 strands. The appearance of each coil set looks almost identical to the winding shown in FIG. 11, except that FIG. 11 does not show the large number of wires.

Referring to FIG. 12, it illustrates a three-dimensional view of a coil 1202 on a transfer tool 1204. In automatic stator manufacturing, coils are wound on coil forms and then placed onto a transfer tool such as transfer tool 1204 before being inserted into the stator slots. Transfer tool 1204 includes racks 1206 to place coils such as coil 1202 on. Coil 1202 on transfer tool 1204 has 4 turns of 3 strands.

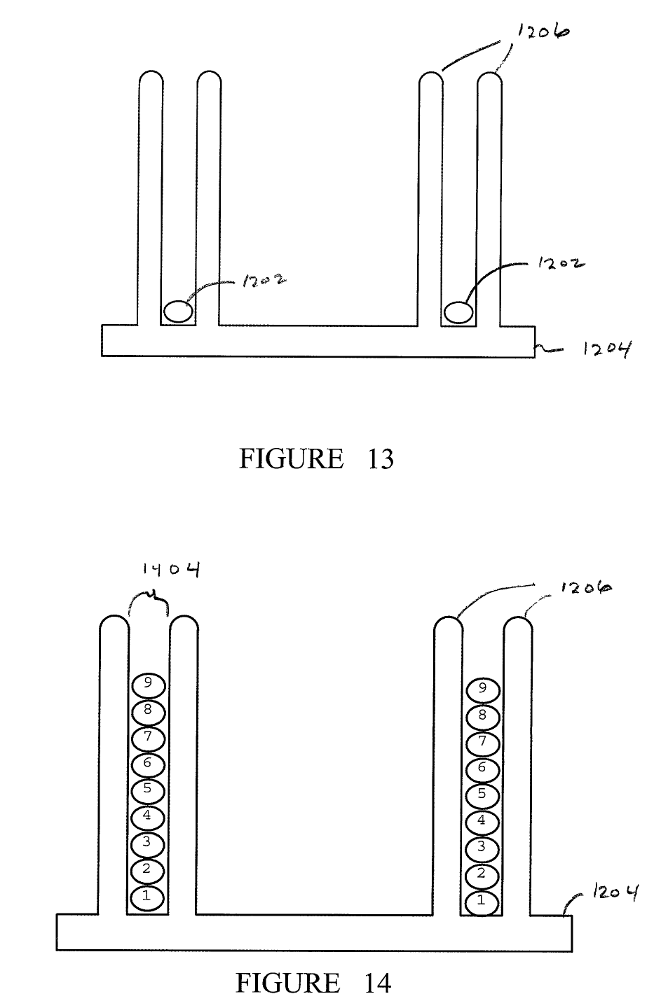

Referring to FIG. 13, it illustrates a two-dimensional view of coil 1204 on transfer tool 1204.

Referring to FIG. 14, it shows 9 coils being installed on a transfer tool in an orderly format. Each coil has 4 strands of 3 strands in parallel. Thus, if the two ends of each coil are connected in parallel, these 9 coils are mechanically and electrically equivalent to a coil with 4 strands of 27 strands in parallel. In fact, this procedure is exactly how a 27 strand in parallel winding is fabricated. Having formed such a composite coil, each coil can not be distinguished individually. All that can be observed is the group of 108 (i.e. 27×4) wires. However, in practice, the specified winding can be considered as a 9 coil set stacked in a orderly format, with each coil stack similar in conception to that shown in FIG. 14.

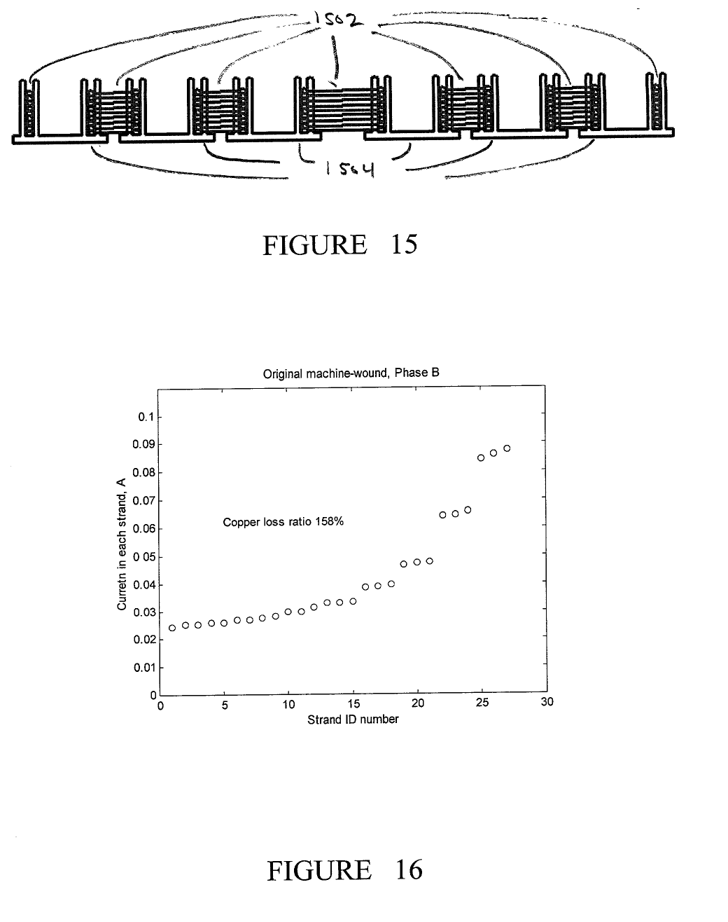

Referring to FIG. 15, it shows winding 1502 located on a coil transfers tool. The nature of a random-wound winding does not produce such an “orderly” wire layout as that shown in FIG. 15. However, through an intentional control feature, such as for example gap 1404 between racks 1206 as shown in FIG. 14, the coils are held in at least a relative position to each other.

During a normal coil insertion process, wires on top of the stack, such as coil #9 in FIG. 14, will be inserted close to a slot bottom area, and the wires at the bottom of the stack, such as coil #1 in FIG. 14, will be inserted close to a slot opening. This ordered assembly can be maintained for all the coils in a winding. Therefore, for each winding after insertion, an average position of each numbered coil is in relatively the same position with respect to the slot opening.

The relative placement of all the coils and hence all the strands in approximately the same position with respect to the slot opening promotes the afore-mentioned current migration problem. For example, a current at 1600 Hz (the rated frequency for the stator) was injected into a phase winding wound with coil transfer tool 1504 of FIG. 15. Current in each of the 27 strands was measured. Referring to FIG. 16, the current value in each strand is plotted from the minimum wire or strand identification number to the maximum wire or strand identification number.

FIG. 16 shows that the current migration problem at the 1600 Hz current is severe. Some of the strands carry four times the currents of other strands. The fact that conduction loss is I²R aggravates the heating problem, because the strands with four times the current have 16 times the conduction loss, which can cause premature insulation breakdown and winding failure. FIG. 16 also shows a copper loss ratio of 158%, which means the conduction loss of such a winding is 158% of what it would be for a winding with an ideally uniform current distribution among strands. This indicates that, in addition to the heating problem, there is a significant problem regarding efficiency of any electrical machine with this disparity of current distribution on the windings. Such disparity in current flow is undesirable in a high frequency electrical machine.

To mitigate this disparity in current distribution, the present invention utilizes in one embodiment a wiring transpose between respective coil layers (i.e between the coil layers numbered coil #1 through coil #9 in FIG. 14). As stated previously, there are a number of obstacles opposing the implementation of transposes in a random-wound winding: the large number of wires, the feeding of the wires of the coils through a narrow slot opening, and the softness of the wires all leading to an unpredictability as to the exact position of each wire in the slot.

However, the inventors have discovered that a significant improvement is achieved by implementing a tooling design and process control configured to provide a relatively orderly format to winding the random-wound windings, thus facilitating a wiring transpose between coils in a winding. Rather than providing a wiring transpose for each wire, in one embodiment of the present invention, a transpose between coils in the winding is provided. Providing a wiring transpose between selected coils is feasible and effective (as to be shown later).

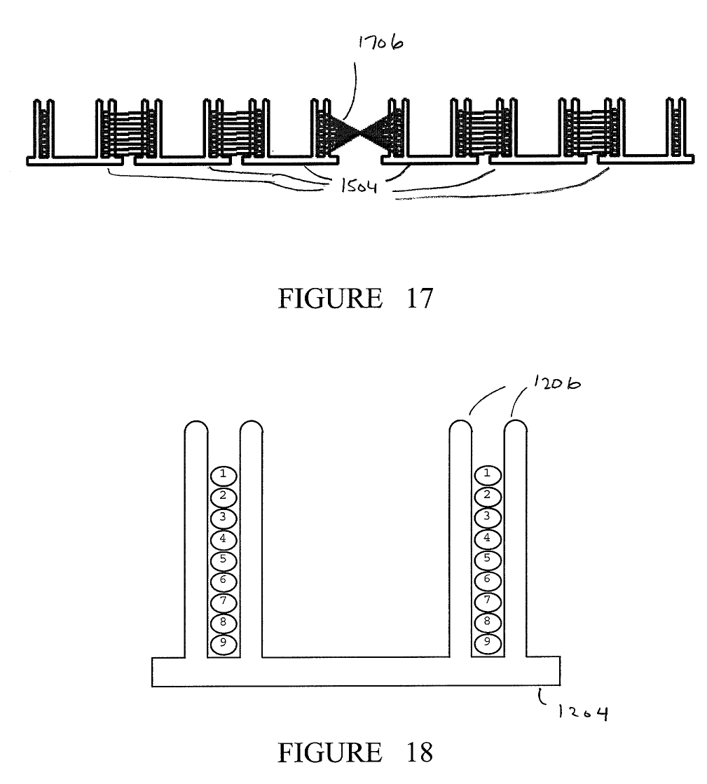

Based on the above principles, gap 1404 between racks 1206 on a coil transfer tool such as coil transfer tool 1204 are designed, according to the present invention, to assure a fixed and consistent positional relation among the coils. Referring to FIG. 17, wiring transpose 1706 is made by inverting (i.e. flipping over) at a mid-position of the coil sets. After wiring transpose 1706 has been made, each of the three coils on the left remains in the same order as shown in FIG. 14.

Referring to FIG. 18, it shows a two-dimensional perspective the ordering of the nine coil layers on the right of coil transfer tool 1504 in FIG. 17. FIG. 18 shows that the order is reversed for the nine coil layers on the right as compared to the order for the nine coil layers on the right in FIG. 14.

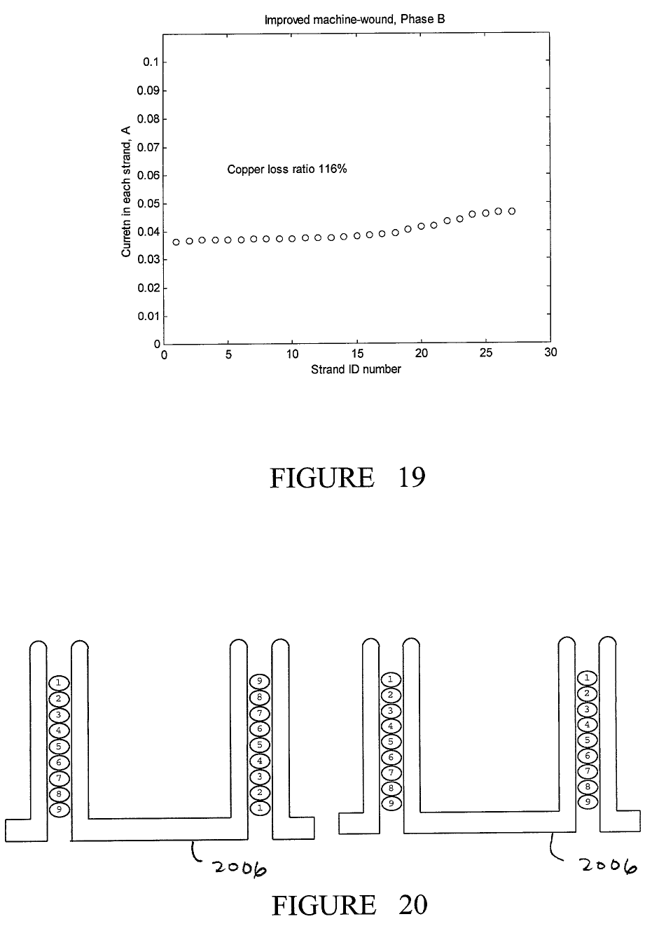

To verify the effect of wiring transpose 1706 between coils in a random-wound windings, a similar experiment was conducted as in FIG. 16 with a 1600 Hz current being applied to a random-wound winding similar to the winding of FIG. 16, but with the wiring transpose. Referring to FIG. 19, it shows that the resulting current distribution is substantially more uniform. The current migration problem has been greatly mitigated. As shown by comparison of FIG. 16 with FIG. 19, when using the winding transpose of the present invention, the current distribution between strands is more uniformly distributed, and the nominal I²R loss is reduced from the original 158% to 116%.

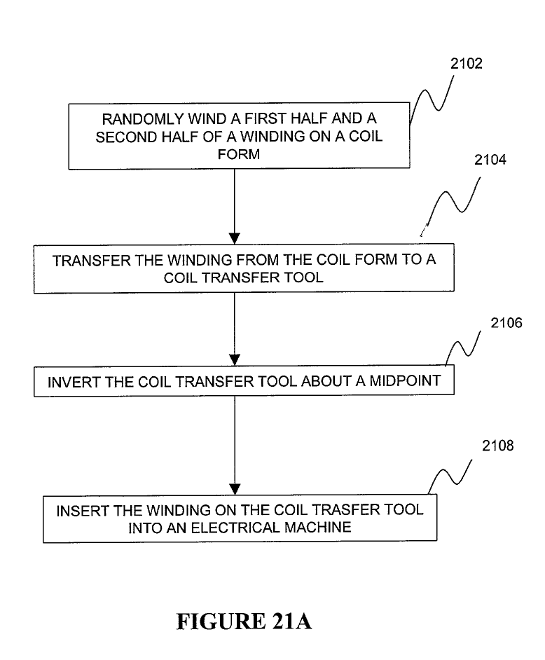

Referring to FIG. 20, another embodiment of the present invention is shown which provides an internal transpose of the coil order within a parallel-wired coil set. Here, within the parallel-wired coil set, one side has a layering order which is inverted with respect to an order on the other side. Since each numbered coil of the coil set is connected to the corresponding numbered coil, the inversion of the order causes the average position of each numbered coil in the stator slot to be the same (i.e. the average position is a position midway between the slot opening and the slot bottom). Thus, according to this embodiment of the present invention, the current migration problem will be mitigated by using an internal transpose of coil order. One way to implement such a transpose is to sequentially remove one half of the coil layers from a bottom of coil form 2006 and reinserting the removed half back onto a top of coil form 2006.

Hence, the present invention enables a high-frequency electric machine to use conventional magnet wires rather than Litz wire. The invention increases significantly the performance/cost ratio of high-frequency motors and generators. In addition, automatic stator equipment may be used for high performance HF stators in motors and generators that include transposed windings of the present invention.

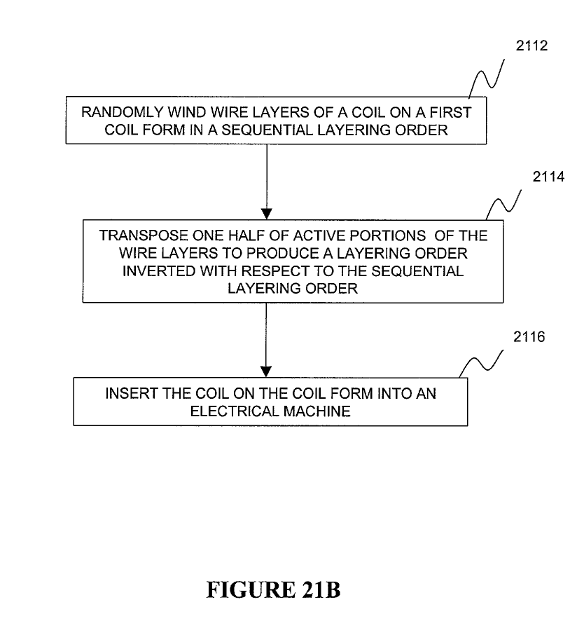

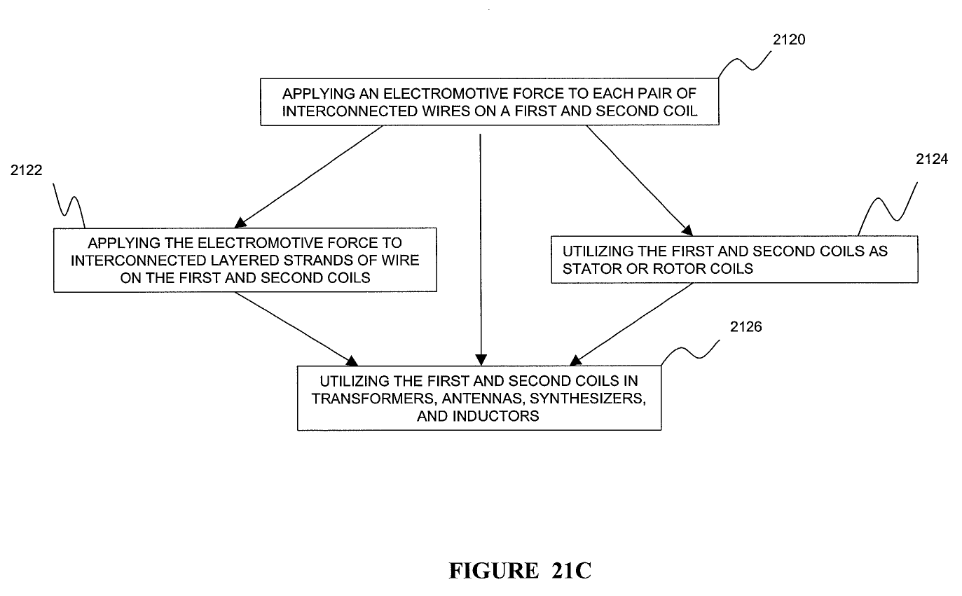

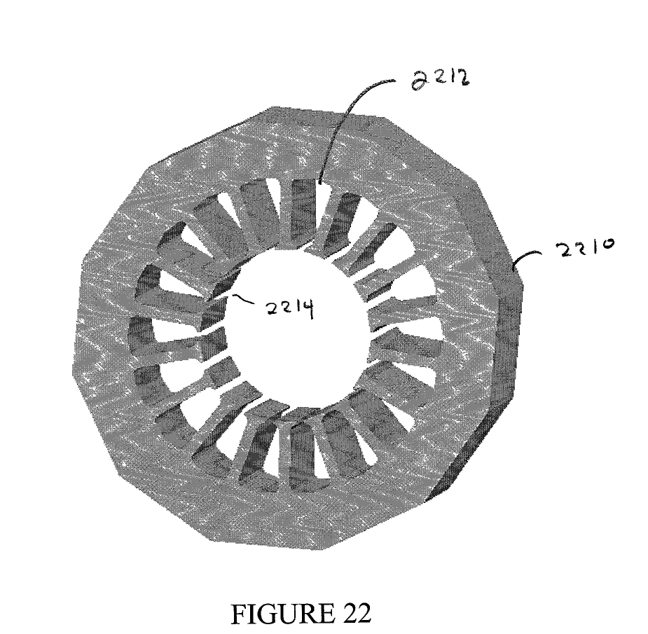

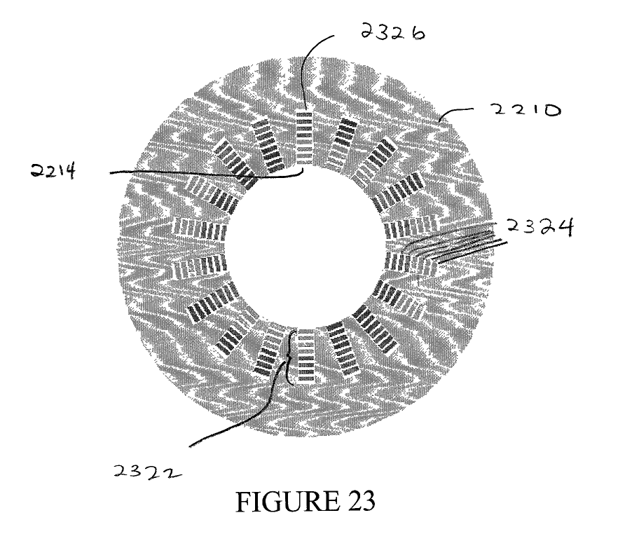

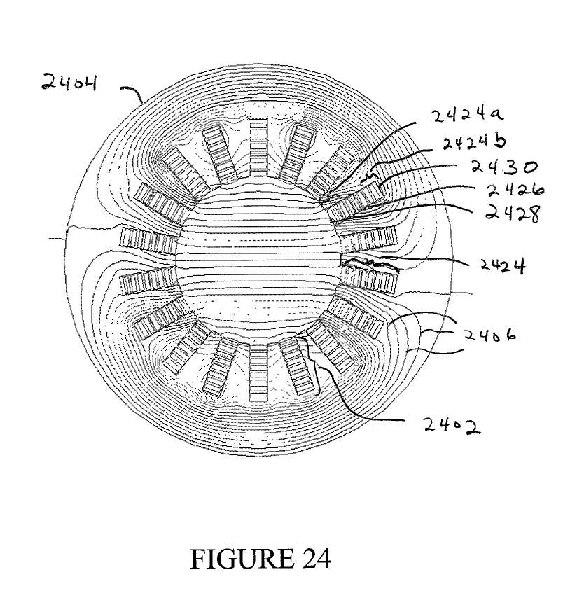

Referring to FIG. 21A, it shows a flowchart depicting one method of making a high frequency electrical machine of the present invention. At step 2102, a winding is randomly wound in a first half and a second half on a coil form. At step 2104, the winding is transferred from the coil form to a coil transfer tool. At step 2106, the coil transfer tool is inverted about a midpoint. At step 2108, the winding with one half now inverted is inserted into an electrical machine.

The step 2102 of winding can wind layered strands of electrically insulated wires. Each of the layered strand of the winding exhibits substantially similar impedances. Braided or unbraided wires can be wound on the windings.

The step 2108 of inserting can insert the winding into a stator or rotor of an electrical motor or generator.

Referring to FIG. 21B, it shows a flowchart depicting another method of making a high frequency electrical machine of the present invention. At step 2112, wire layers of a coil are randomly wound on a coil form in a sequential layering order. At step 2114, one half of active portions of the wire layers (e.g. the far right side of the layers shown in FIG. 20) are transposed to produce a layering order inverted with respect to the sequential layering order. At step 216, the coil on the coil form is inserted into an electrical machine.

The step 2112 of winding can wind braided or unbraided wires.

The step 2114 of transposing can transpose the sequential layering order of one half of the active portions by sequentially removing one half of the active portions from a bottom of the coil form and reinserting the removed active portions back onto a top of the coil form.

Referring to FIG. 21C, it shows a flowchart depicting a method of using a high frequency electrical machine of the present invention. At step 2120, an electromotive force is applied to each pair of interconnected wires to produce substantially similar currents in each pair of interconnected wires on a first and second coil. At step 2122, the electromotive force is applied to interconnected layered strands. At step 2124, the first and second coils are stator or rotor coils. At step 2126, the first and second coils are utilized in transformers, antennas, synthesizers, and inductors.

Numerous modifications and variations of the present invention are possible in light of the above teachings. It is therefore to be understood that within the scope of the appended claims, the invention may be practiced otherwise than as specifically described herein.

1. A random-wound winding for an electrical machine, comprising:
interconnected wire layers, wherein the interconnected wire layers include randomly wound wires and are configured upon placement in the electrical machine to have substantially the same impedance.

2. The winding according to claim 1, further comprising:
a first coil including layers of wires randomly wound as the first coil, layers of the first coil configured in a first layering order;
a second coil including layers of wires randomly wound as the second coil, layers of the second coil configured in a second layering order transposed relative to the first layering order; and
at least one electrical interconnection configured to serially connect said layers of the first coil to said layers of the second coil to produce said interconnected wire layers such that an average axial position of all interconnected wire layers is substantially the same.

3. The winding according to claim 2, wherein said at least one electrical interconnection produces substantially similar impedances for wire strands in each of said interconnected layers.

4. The winding according to claim 2, wherein said at least one electrical interconnection produces for a given electromotive force substantially similar currents across each of said interconnected layers.

5. The winding according to claim 2, wherein the layers of said first coil and the layers of said second coil comprise:
layered strands of electrically insulated wires.

6. The winding according to claim 5, wherein said at least one electrical interconnection is configured to produce substantially similar impedances across each of said layered strands.

7. The winding according to claim 5, wherein said at least one electrical interconnection is configured to produce for a given electromotive force substantially similar currents across each of said layered strands.

8. The winding according to claim 2, wherein said first coil and said second coil are configured as stator coils.

9. The winding according to claim 8, wherein said stator coils are at least one of motor stator coils and generator stator coils.

10. The winding according to claim 2, wherein said first coil and said second coil are configured as rotor coils.

11. The winding according to claim 11, wherein said rotor coils are at least one of motor rotor coils and generator rotor coils.

12. The winding according to claim 2, wherein said wires randomly wound on the first coil and said wires randomly wound on the second coil comprise braided wires.

13. The winding according to claim 2, wherein said wires randomly wound on the first coil and said wires randomly wound on the second coil comprise unbraided wires.

14. The winding according to claim 1, wherein said interconnected wire layers comprise:
layers of wires randomly wound on a coil form with one side of the coil having said layers of wires configured in a first layering order and an opposing side of the coil having said layers of wires configured in a second layering order transposed relative to the first layering order, and an average axial position of said layers of wires is substantially the same.

15. The winding according to claim 14, wherein one of said layers of wires has substantially the same impedance as another of said layers of wires.

16. The winding according to claim 14, wherein for a given electromotive force substantially the same current flow in each of said layers of wires.

17. The winding according to claim 14, wherein said layers of wires comprise:
layered strands of electrically insulated wires.

18. The winding according to claim 14, wherein said coil is configured as stator coil.

19. The winding according to claim 18, wherein said stator coil is at least one of a motor stator coil and a generator stator coil.

20. The winding according to claim 14, wherein said coil is configured as a rotor coil.

21. The winding according to claim 20, wherein said rotor coil is at least one of a motor rotor coil and a generator rotor coil.

22. The winding according to claim 14, wherein said wires randomly wound on the coil comprise braided wires.

23. The winding according to claim 14, wherein said wires randomly wound on the coil comprise unbraided wires.

24. A high frequency electrical machine, comprising:
a first coil including layers of wires randomly wound as the first coil, layers of the first coil configured in a first layering order;
a second coil including layers of wires randomly wound as the second coil, layers of the second coil configured in a second layering order transposed relative to the first layering order; and
at least one electrical interconnection configured to serially connect said layers of the first coil to said layers of the second coil such that an average position in slots of all interconnected layers is substantially the same.

25. The machine of claim 24, wherein the high frequency electrical machine comprises a turbogenerator.

26. The machine of claim 25, wherein the turbogenerator comprises:
a compressor configured to compress a fuel oxidizer;
a fuel supplier configured to supply fuel to the turbogenerator;
a combustor connected to an exhaust of the compressor and configured to combust the fuel and the fuel oxidizer into a combusted gas;
a turbine attached to an exhaust of said combustor and configured to convert heat from the combusted gas into rotational energy; and
a motor/generator configured to convert the rotational energy in the turbine into electrical energy.

27. The machine of claim 24, wherein the first coil is at least one of a rotor coil and a stator coil.

28. The machine of claim 24, wherein the second coil is at least one of a rotor coil and a stator coil.

29. The machine of claim 24, wherein the high frequency electrical machine comprises at least one of a motor, a generator, a transformer, an antenna, a synthesizer, and an inductor.

30. A high frequency electrical machine, comprising:
a coil including layers of wires randomly wound on the coil with one side of the coil having the layers configured in a first layering order and an opposing side of the coil having the layers configured in a second layering order transposed relative to the first layering order,
wherein an average axial position of the layers is substantially the same.

31. The machine of claim 30, wherein the high frequency electrical machine comprises a turbogenerator.

32. The machine of claim 31, wherein the turbogenerator comprises:
a compressor configured to compress a fuel oxidizer;
a fuel supplier configured to supply fuel to the turbogenerator;
a combustor connected to an exhaust of the compressor and configured to combust the fuel and the fuel oxidizer into a combusted gas;
a turbine attached to an exhaust of said combustor and configured to convert heat from the combusted gas into rotational energy; and
a motor/generator configured to convert the rotational energy in the turbine into electrical energy.

33. The machine of claim 30, wherein the coil is at least one of a rotor coil and a stator coil.

34. The machine of claim 30, wherein the high frequency electrical machine comprises at least one of a motor, a generator, a transformer, an antenna, a synthesizer, and an inductor.

35. A method of making a high frequency electrical machine, comprising the steps of:
winding randomly layers of a first half and a second half of a winding on a coil form;
transferring the winding from the coil form to a coil transfer tool;
inverting the coil transfer tool about a midpoint; and
inserting the layers of the winding on the coil transfer tool into an electrical machine.

36. The method according to claim 35, wherein the step of winding comprise:
winding layered strands of electrically insulated wires.

37. The method according to claim 35, wherein the step of inserting produces on the inserted winding interconnected layers having substantially similar impedances.

38. The method according to claim 35, wherein said steps of winding comprise:
winding braided wires.

39. The method according to claim 35, wherein said steps of winding comprise:
winding unbraided wires.

40. The method according to claim 35, wherein said steps of winding comprise:
winding separate coil sets on the coil transfer tool.

41. The method according to claim 40, further comprising:
inserting layers of the coil sets from the coil transfer tool into at least one of a stator and a rotor of at least one of an electrical motor and an electrical generator.

42. A method of making a high frequency electrical machine, comprising the steps of:
winding randomly wire layers of a coil on a coil form in a sequential layering order;
transposing one half of active portions of the wire layers to produce a layering order for the one half inverted with respect to the sequential layering order; and
inserting the wire layers of the coil on the coil form into an electrical machine.

43. The method according to claim 42, wherein the step of winding comprise:
winding layered strands of electrically insulated wires.

44. The method according to claim 43, wherein said step of inserting produces substantially similar impedances across each of the wire layers of the coil.

45. The method according to claim 42, wherein said step of winding comprises:
winding braided wires.

46. The method according to claim 42, wherein said step of winding comprises:
winding unbraided wires.

47. The method according to claim 42, wherein the step of transposing comprises:
transposing the sequential layering order of one half of the active portions by sequentially removing said one half from a bottom of the coil form and reinserting the removed active portions back onto a top of the coil form.

48. The method according to claim 47, further comprising:
inserting layers of the coil from the coil transfer tool into at least one of a stator and a rotor of at least one of an electrical motor and an electrical generator.

49. A method of using the winding of claim 2, comprising:
applying an electromotive force to said each pair of interconnected wires to produce substantially similar currents in said each pair.

50. The method according to claim 49, further comprising:
utilizing said first coil and said second coil as stator coils.

51. The method according to claim 50, further comprising:
utilizing said stator coils as at least one of motor stator coils and generator stator coils.

52. The method according to claim 49, further comprising:
utilizing said first coil and said second coil as rotor coils.

53. The method according to claim 52, further comprising:
utilizing said rotor coils as at least one of motor rotor coils and generator rotor coils.

54. The method according to claim 49, wherein said step of applying comprises:
applying the electromotive force to said all interconnected layers on said first coil and said second coil.

55. The method according to claim 49, further comprising:
utilizing said first coil and said second coil in at least one of a transformer, an antenna, a synthesizer, and an inductor.

56. A method of using the winding of claim 14, comprising:
applying an electromotive force to said layers to produce substantially similar currents in said each of said layers.

57. The method according to claim 56, further comprising:
utilizing the coil as a stator coil.

58. The method according to claim 57, further comprising:
utilizing said stator coil as at least one of a motor stator coil and a generator stator coil.

59. The method according to claim 56, further comprising:
utilizing the coil as a rotor coil.

60. The method according to claim 59, further comprising:
utilizing the rotor coil as at least one of a motor rotor coil and a generator rotor coil.

61. The method according to claim 56, further comprising:
utilizing the coil in at least one of a transformer, an antenna, a synthesizer, and an inductor.
